(19) United States
(12) Patent Application Publication
(10) Pub. No.: US 2003/0005674 A1
(43) Pub. Date: Jan. 9, 2003

(54) Support assembly guide for a weed and grass trimmer

(76) Inventor: Judy C. Powell, Star, ID (US)

Correspondence Address: Charles R. Clark, P.O. Box 842, Boise, ID, 83701-0842, US

(21) Appl. No.: 10/190,222

(22) Filed: Jul. 5, 2002

Related U.S. Application Data
(60) Provisional application No. 60/303,487, filed on Jul. 5, 2001.

(51) Int. Cl. A01D 34/00

(52) U.S. Cl. 56/12.7

(57) ABSTRACT

A novel apparatus for the support and guiding of a weed and grass trimmer is disclosed. The invention attaches to gas and electric weed and grass trimmers and permits a user to more easily use the trimmer and space and maintain a selected height of the cutting plane of the trimmer above the work surface, generally the surface of the earth.

### CROSS-REFERENCE TO RELATED APPLICATIONS

This application claims the benefit of U.S. Provisional Application No. 60/303,487, filed Jul. 5, 2001.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention relates to a novel apparatus for the support and guiding of a weed and grass trimmer. The invention attaches to gas and electric weed and grass trimmers. It permits the user to more easily use the trimmer and space and maintain a selected height of the cutting plane of the trimmer above the ground.

Generally, a conventional weed and grass trimmer has a rotating head, the rotating head having a length of line projecting radially from the head rotated in a generally horizontal cutting plane below a shield while supported at the end of a trimmer tube, adjacent a work surface. Generally, the conventional trimmer has the shield located above and in near proximity to the cutting plane. The work surface is generally the surface of the earth. The line, as it spins in the cutting plane, cuts weeds and grass that are struck by the line. Many rotating heads have a bump-type line feed mechanism that advances the line after wear by bumping the mechanism against the ground.

A number of support devices exist that can aid a person in using a weed and grass trimmer. In U.S. Pat. No. 5,477,665 issued to Stout is disclosed a support strut assembly for a rotating flexible line-type vegetation trimmer. This prior invention uses a different and more complex assembly for the support of the trimmer.

### BRIEF SUMMARY OF THE INVENTION

A principal objective of this invention is to provide a novel and improved support assembly guide for a weed and grass trimmer to provide support for the trimmer in a spaced arrangement from the grass or other surface over which the trimmer is used. Preferably, the invention attaches to a trimmer tube of a weed and grass trimmer. Alternatively, the invention attaches to a shield of the weed and grass trimmer. The invention eases the work load of the user by assisting the user in the support of the trimmer.

A further object of the invention is to provide a smooth and relatively consistent surface for the bumping of a bump-type line feed mechanism, a mechanism that is common on many weed and grass trimmers.

Additional and various other objects and advantages attained by the invention will become more apparent as the specification is read and the accompanying figures are reviewed.

### BRIEF DESCRIPTION OF THE SEVERAL VIEWS OF THE DRAWING

FIG. 1 is a side elevational view of a support assembly guide for a weed and grass trimmer;

FIG. 1A is a partial top plan view showing a bowed support shaft securely joined to a dished disc by welding;

FIG. 2 is a perspective view of the support assembly guide adjustably attached to a trimmer tube;

FIG. 3 is an exploded view of a quick release mount;

FIG. 4 is a side elevational view of an alternative support assembly guide;

FIG. 5 is a rear elevational view of the alternative support assembly guide shown in FIG. 4;

FIG. 6 is a top plan view of an alternative embodiment of the dished disc; and

FIG. 7 is a partial side elevational view of an alternative embodiment of the support assembly guide, showing a dished disc, a sleeve, and a bowed support shaft.

### DETAILED DESCRIPTION OF THE INVENTION

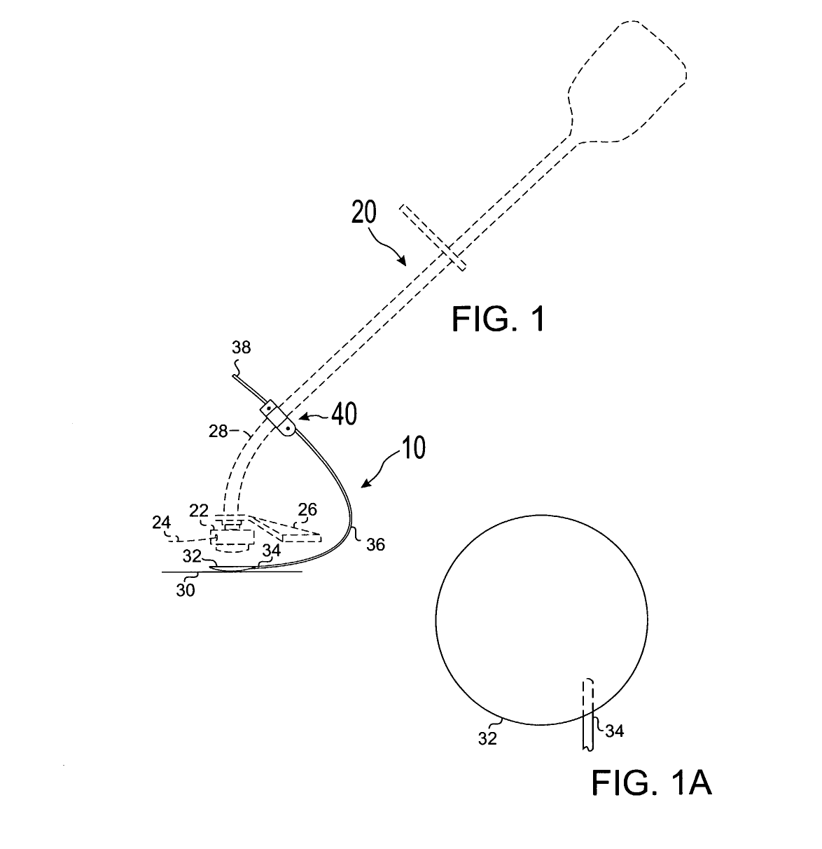

Referring to FIG. 1, the present invention is novel and provides a support assembly guide 10 for a weed and grass trimmer 20. The trimmer 20 has a rotating head 22. The rotating head 22 has a length 24 of line projecting radially from the head rotated in a generally horizontal cutting plane below a shield 26 while supported at the end of a trimmer tube 28, adjacent a work surface 30.

The support assembly guide 10 comprises a concave, dished disc 32 that preferably is about five inches in diameter and fabricated from stainless steel or another suitable material. The disc 32 is securely joined to a first end 34 of a bowed support shaft 36 that preferably is fabricated from stainless steel or from another suitable material or metal or alloy. The shaft 36 can have a round or square or some other cross-section, but a rectangular cross-section is preferred.

Preferably, the disc 32 is welded to the first end 34 of the shaft 36, but the disc can also be securely joined to the first end by rivets or nuts and bolts. The shaft 36 has a second end 38 and the shaft is adjustably clamped near said second end by a clamping assembly 40, and the clamping assembly is adjustably attached to the trimmer tube 28 to position the disc 32 to be coplanar and coaxial to a cutting circle of the trimmer defined by the rotating head 22 rotating the length 24 of line and to be adjustably spaced from the rotating head.

When the trimmer 20 is used and the disc 32 is in contact with a work surface 30, the shaft 36 does not flex appreciably under just the weight of the trimmer 20 and holds the disc 32 adjustably spaced from the rotating head 22 and the guide 10 spaces the cutting circle of the trimmer above the work surface.

Preferably, as shown in FIG. 1A, the disc 32 is joined to the first end 34 along a line parallel to and offset away about an inch (more or less) from a midline of the disc as defined by a straight line across the disc that crosses the center point of the disc. The offset allows a more advantageous operational alignment of the support assembly guide 10 to the trimmer 20. The bottom surface of the disc 32 is rounded and preferably smooth and may be polished to more freely slide on and along a work surface, generally the surface of the earth or grass, while the trimmer is used.

The bowed support shaft 36 is resilient and has a preformed bow shape. When a bending pressure is applied, the shaft 36 flexes from the preformed bow shape and when the bending pressure ceases, the shaft returns to the preformed bow shape. When the preferred embodiment of the invention is attached to a trimmer having a bump-type line feed mechanism and the disc 32 is in contact with a work surface 30 and the user applies a bending pressure (a relative downward vertical pressure) on the trimmer, the shaft 36 being resilient allows a bending of the shaft and a bumping of the mechanism on the top surface of the disc resulting in line feed. The top surface of the disc 32 provides a smooth and consistent surface for the mechanism to bump instead of the ground or other surface thereby lessening wear and tear on the mechanism. After the applied bending pressure ceases, the shaft 36 returns to the preformed shape.

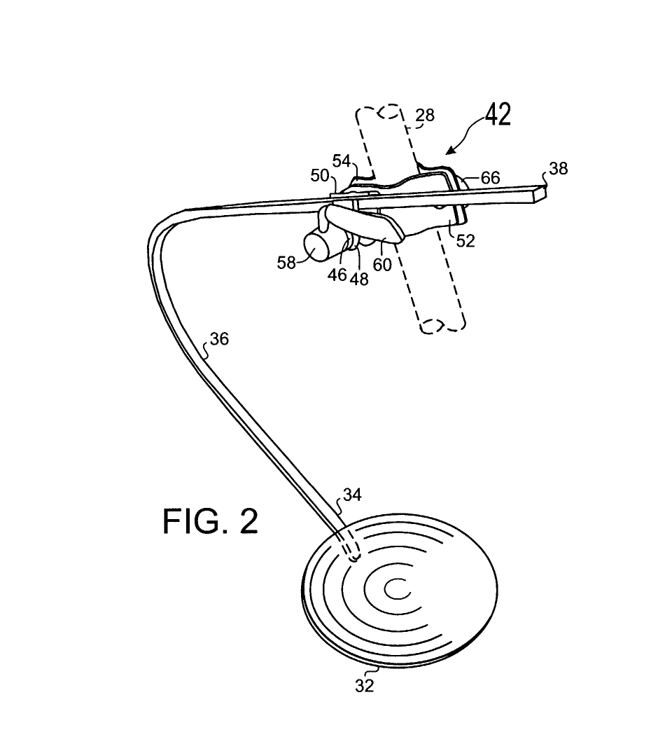

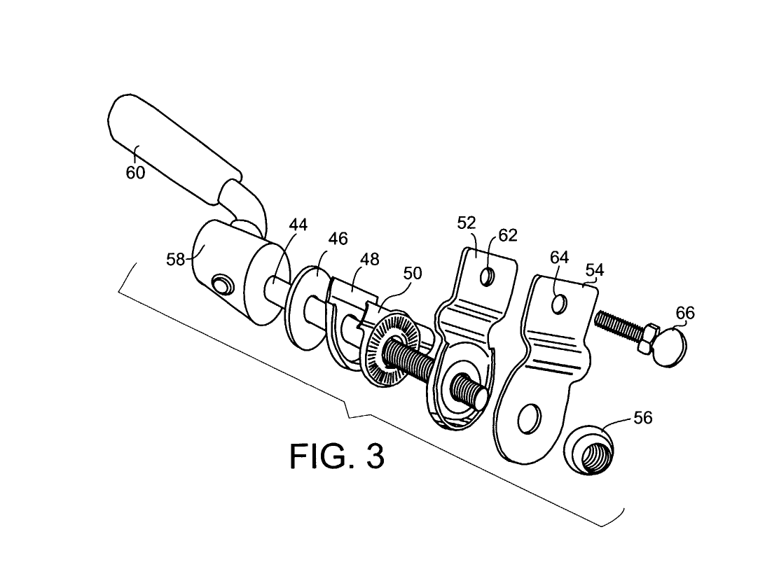

FIGS. 2 and 3 best show that in the preferred embodiment, the clamping assembly 40 is a quick release mount 42 comprising a mounting stud 44 extending axially through a washer 46, a bowed support shaft retainer 48, a bowed support shaft clamp 50, a trimmer tube retainer 52, a trimmer tube clamp 54 and said stud having adjustable retainer members on its ends comprising a nut 56 and an eccentric 58 movable relative to the stud coaxially thereto by a lever 60. As shown in FIG. 2, the quick release mount 42 adjustably clamps the bowed support shaft 36 near the second end 38 of the shaft. Preferably, the trimmer tube retainer 52 and the trimmer tube clamp 54 have two cooperating apertures 62 and 64 for mounting of a closing bolt 66.

Preferably, the aperture 62 is threaded to receive and cooperate with the bolt 66 in drawing the tube retainer 52 and the tube clamp 54 together against the trimmer tube 28 thereby attaching the quick release mount 42 to the trimmer tube. Alternatively, a nut can be used with the bolt 66. Alternatively, the tube retainer 52 and the tube clamp 54 can be formed in one piece that wraps around the tube 28. Other clamping assemblies known in the art could be used.

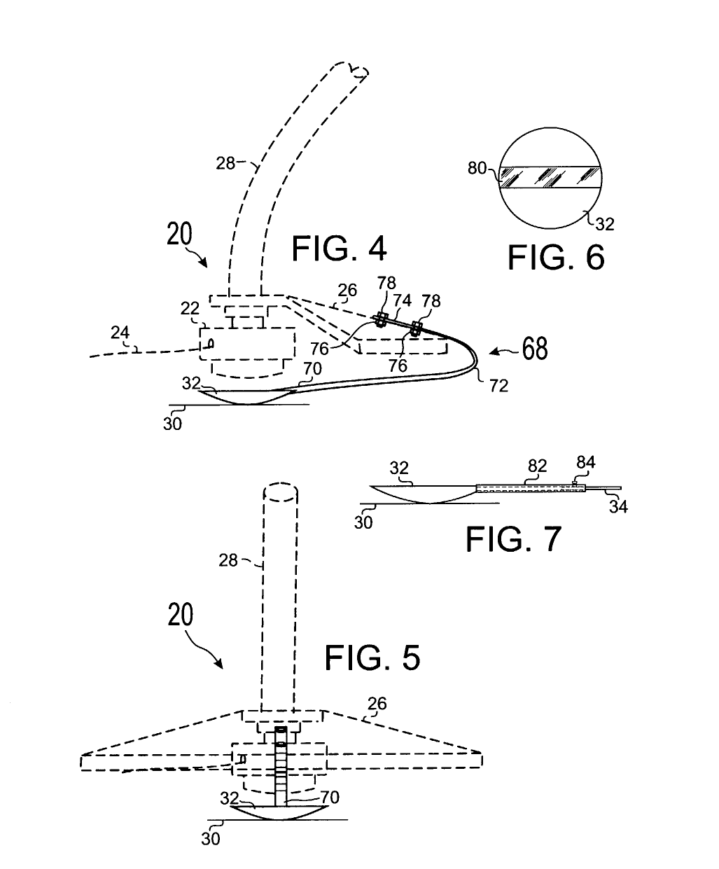

In an alternative support assembly guide 68, as shown in FIGS. 4 and 5, a disc 32 is securely joined to a lower end 70 of a spring member 72. The spring member 72 has an upper end 74. The upper end 74 is attached to a shield 26 of a trimmer 20. The upper end 74 can be attached by use of nuts 76 and bolts 78 or by rivets or by insertion into a cooperating and receiving cavity (not shown) formed in the shield 26. Preferably, in this embodiment, the spring member 72 is bow shaped and has a rectangular cross-section and is sized and shaped to position the disc 32 to be coplanar and coaxial to a cutting circle of the trimmer defined by the rotating head 22 rotating the length 24 of line and to be spaced from the cutting head. Alternatively, additional spring members 72 can be used and attached between the shield 26 and the disc 32.

The spring member 72 is resilient and flexes under applied bending pressure from a preformed bow shape and returns to the preformed bow shape when the applied bending pressure ceases. When the alternative support assembly guide 68 is secured to a shield 26 of a trimmer having a bump-type line feed mechanism and the disc 32 is in contact with a work surface 30 and the user applies a bending pressure (a relative downward vertical pressure) on the trimmer, the member 72 being resilient allows a bending of the member and a bumping of the mechanism on the top surface of the disc resulting in line feed. The top surface of the disc 32 provides a smooth and consistent surface for the mechanism to bump instead of the ground or other surface thereby lessening wear and tear on the mechanism. After the applied bending pressure ceases, the member 72 returns to the preformed shape.

FIG. 6 shows an alternative embodiment in which a bridge 80 is attached across a portion of the upper side of the disc 32. The bridge 80 provides a flat surface for a bump-type line feed mechanism to bump against. Alternatively, the bridge 80 may span the entire upper side.

As shown in FIG. 7, in an alternative embodiment, a sleeve 82 is interposed between a disc 32 and a first end 34 of the bowed support shaft 36. The sleeve 82 is securely joined to the disc 32 and the sleeve adjustably receives and retains the first end 34. Preferably, a set screw 84 secures the first end 34 within the sleeve 82.

In another embodiment not shown, a sleeve 82 is interposed between a disc 32 and a lower end 70 of a spring member 72. The sleeve 82 is securely joined to the disc 32 and the sleeve adjustably receives and retains the lower end 70. Preferably, a set screw 84 secures the lower end 70 within the sleeve 82.

The preceding description and exposition of the invention is presented for purposes of illustration and enabling disclosure. It is neither intended to be exhaustive nor to limit the invention to the precise forms disclosed. Modifications or variations in the invention in light of the above teachings that are obvious to one of ordinary skill in the art are considered within the scope of the invention as determined by the appended claims when interpreted to the breath to which they fairly, legitimately and equitably are entitled.

I claim:

1. A support assembly guide for a weed and grass trimmer of the type having a rotating head, said rotating head having a length of line projecting radially from said head rotated in a generally horizontal cutting plane below a shield while supported at the end of a trimmer tube, adjacent a work surface, wherein the improvement comprises:
a disc, said disc securely joined to a first end of a bowed support shaft, said bowed support shaft having a second end, said bowed support shaft adjustably clamped near said second end by a clamping assembly, said clamping assembly adjustably attached to said trimmer tube, whereby said disc is adjustably spaced from said rotating head.

2. A guide according to claim 1 wherein said rotating head further comprises a bump-type line feed mechanism.

3. A guide according to claim 1 wherein a sleeve is interposed between said disc and said first end of said bowed support shaft, said sleeve securely joined to said disc, and said sleeve adjustably receives and retains said first end.

4. A guide according to claim 2 wherein a sleeve is interposed between said disc and said first end of said bowed support shaft, said sleeve securely joined to said disc, and said sleeve adjustably receives and retains said first end.

5. A support assembly guide for a weed and grass trimmer of the type having a rotating head, said rotating head having a length of line projecting radially from said head rotated in a generally horizontal cutting plane below a shield while supported at the end of a trimmer tube, adjacent a work surface, wherein the improvement comprises:
a disc, said disc securely joined to a lower end of a spring member, said spring member having an upper end, said upper end secured to said shield, whereby said disc is spaced from said rotating head.

6. A guide according to claim 5 wherein said rotating head further comprises a bump-type line feed mechanism.

7. A guide according to claim 5 wherein a sleeve is interposed between said disc and said lower end of said spring member, said sleeve securely joined to said disc, and said sleeve adjustably receives and retains said lower end.

8. A guide according to claim 6 wherein a sleeve is interposed between said disc and said lower end of said spring member, said sleeve securely joined to said disc, and said sleeve adjustably receives and retains said lower end.
